(19) United States
(12) Patent Application Publication
(10) Pub. No.: US 2008/0250164 A1
(43) Pub. Date: Oct. 9, 2008

(54) RECORDING MULTIMEDIA DATA ON REMOVABLE STORAGE DEVICE

(76) Inventor: Jaan-Huei Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/048,226

(22) Filed: Mar. 14, 2008

Related U.S. Application Data
(60) Provisional application No. 60/909,944, filed on Apr. 4, 2007.

(51) Int. Cl. G06F 12/02

(52) U.S. Cl. 710/13

(57) ABSTRACT

An apparatus for recording multimedia data includes a removable storage device and a controller. The controller records multimedia data onto the removable storage device without modifying a file system of the removable storage device when the removable storage device having free space is attached and detected. Therefore, no data is flushed into the removable storage device when the removable storage device is removed, and the time-shifting function can be stopped easily.

### CROSS REFERENCE TO RELATED APPLICATIONS

This application claims the benefit of U.S. Provisional Application No. 60/909,944, filed on Apr. 04, 2007 and included herein by reference.

### BACKGROUND

The present invention relates to a method of recording multimedia data and an apparatus thereof, and more particularly, to a method of recording multimedia data into a removable storage device without modifying a file system of the removable storage device, and an apparatus thereof.

A recorder, set-top box or TV set having a time-shifting function can record programming to a hard disk drive (HDD), and allows users to view or listen to the recorded programming at a convenient time. The hard disk drive, however, is relatively more expensive than other storage mediums, such as DVDs. Some manufacturers have developed DVD recorders that record programming onto DVDs, but the response speed is slow due to its mechanical limitations and DVDs are scratched easily. Although Dynamic Random Access Memory (DRAM) is another generally developed storage medium used to store data, the memory capacity of a DRAM is limited in that it can only buffer several seconds of programming, which is not suitable for practical uses. A convenient storage medium for recording multimedia data is therefore necessary.

### SUMMARY

One objective of the present invention is to provide a method of recording multimedia data and an apparatus thereof. The multimedia data is automatically recorded when a removable storage device having free space is attached and detected, and the data is recorded without modifying a file system of the removable storage device. Therefore there is no need to flush any data into the removable storage device when a removal of the removable storage device is detected, and the time-shifting function can be stopped easily. The removable storage device is implemented by a memory card in one embodiment. Since a memory card does not suffer mechanical limitations such as those of the DVD, the present invention is able to prevent the effect of the fragmentation. In addition, the present invention takes the advantages of the memory card, such as large memory capacity, low production cost, quick response, popularity and resistance to scratching, and etc . . . , to enhance the efficiency of time-shift operation.

According to an exemplary embodiment of the present invention, a method of recording multimedia data is disclosed. The method comprises providing a removable storage device, and recording multimedia data into the removable storage device without modifying a file system of the removable storage device.

According to another exemplary embodiment of the present invention, an apparatus for recording multimedia data is disclosed. The apparatus comprises a removable storage device and a controller. The controller is coupled to the removable storage device, and records multimedia data into the removable storage device without modifying the file system of the removable storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a memory card applied in a TV set system according to an exemplary embodiment of the present invention.

FIG. 2 is a diagram showing space allotment of a memory card.

FIG. 3 is a diagram showing overwriting multimedia data on a used space of a memory card having multimedia data recorded therein.

FIG. 4 is a diagram showing a memory card applied in a DVD recorder system according to an exemplary embodiment of the present invention.

FIG. 5 is a diagram showing recording multimedia data on a memory card and a DVD disc at the same time.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

In order to overcome the problems of prior arts, an apparatus for recording multimedia data disclosed by the present invention includes a removable storage device and a controller. When detecting a coupling of the removable storage device, the controller further detects if there is free space in the removable storage device. When the detection result indicates that there is free space, the controller starts recording multimedia data into the removable storage device without modifying the file system of the removable storage device, until a removal of the removable storage device is detected. The removable storage device is not limited but is preferred to be implemented by a memory card since a memory card is cheaper, more popular, not easily scratched, and has a larger memory capacity and a quicker response than conventional storage mediums used in prior arts.

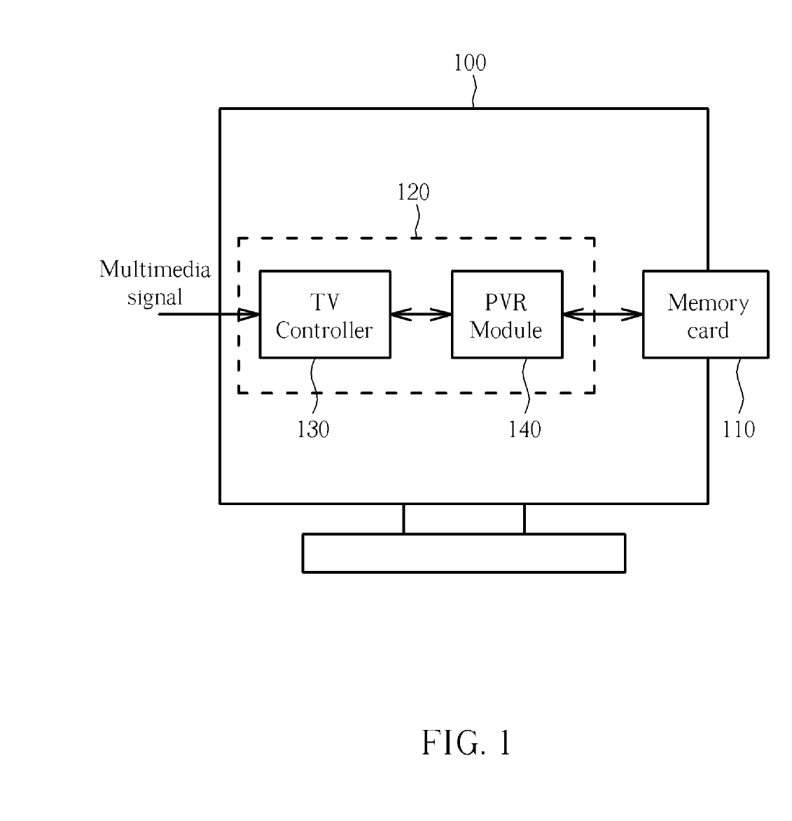

Please refer to FIG. 1. FIG. 1 is a diagram showing the memory card 110 applied in a TV set system 100 with a memory card interface according to an exemplary embodiment of the present invention. The TV set system 100 includes a controller 120 including a TV controller 130 and a personal video recorder (PVR) module 140. Please note that FIG. 1 only shows elements that are pertinent to technical features of the present invention. The TV controller 130 is in charge of displaying functions of the TV set system 100, such as playing the received multimedia signal on the TV screen. The PVR module 140 performs time-shifting function, and audio/video/control signals can be bi-directionally transmitted between the PVR module 140 and the TV controller 130. Although the TV controller 130 and the PVR module 140 are two individual elements in this embodiment, they can be combined together; for example, they can be installed in the same chip in another embodiment.

The PVR module 140 detects whether a memory card 110 is inserted. When an attachment of the memory card 110 is detected, the PVR module 140 further detects if there is free space in the memory card 110, and sends a notice to the TV controller 130 to show a message on the TV screen. The message may include a control menu that allows the user to play contents stored in the memory card 110 or to start other functions. Detailed descriptions of these functions will be introduced later.

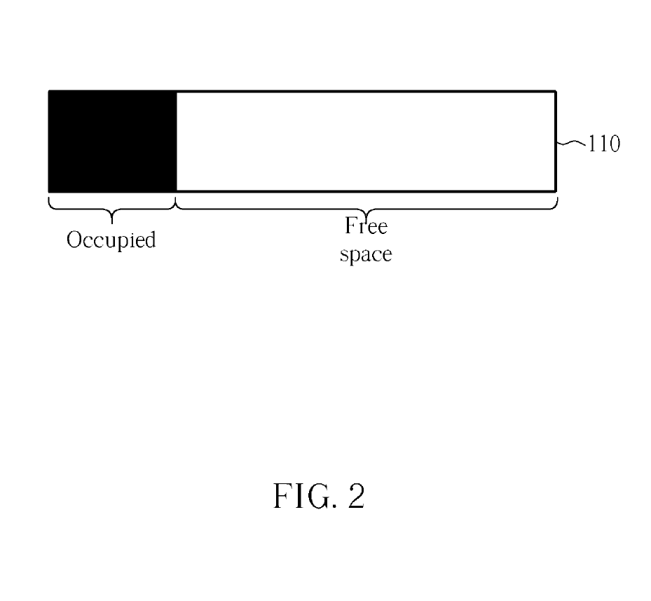

When the detection result indicates that there is free space in the memory card 110 as shown in FIG. 2 (where the occupied region in FIG. 2 represents data formerly stored with titles in a file system of the memory card 110), the time-shift recording function starts automatically. That is, the multimedia data is recorded in the free space of the memory card 110 automatically when the memory card 110 is inserted into the TV set system 100. In one embodiment, the PVR module 140 determines an encoding quality according to the size of the free space, and then encodes the multimedia data according to the encoding quality before the multimedia data is recorded into the free space. For example, when the free space is large, the encoding quality can be higher than standard in order to provide higher picture quality, and when the free space is small, the encoding quality can be lower in order to save memory space. The controller 120 records the encoded multimedia data into the free space of the memory card 110 directly, without modifying the file system of the memory card 110. In this way, the free space of the memory card 110 is utilized as a buffer. Therefore, original content stored in the memory card 110 is not influenced, and no data needs to be flushed in the memory card 110 when the time-shifting operation is stopped. The memory card 110 can be directly removed from the TV set system 100 at any time.

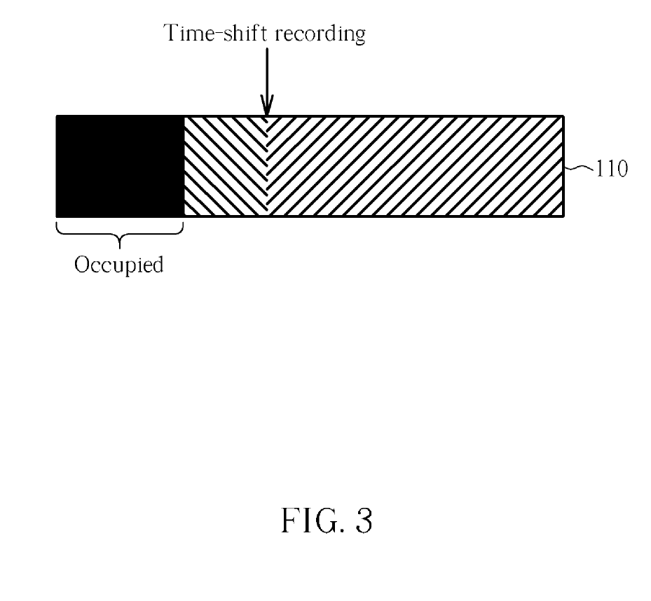

The user can request to play contents of the memory card 110 (the multimedia file formerly stored in the occupied region or the multimedia data newly stored in the free space) while recording is continuing. Moreover, when the memory card 110 is full but the multimedia data is still being recorded (i.e. the memory card 110 is still inserted), the controller 120 may overwrite the multimedia data on a used space of the memory card 110 having the multimedia data recorded therein. For example, as shown in FIG. 3, the controller 120 may overwrite the multimedia data from the beginning of the space except for the occupied space.

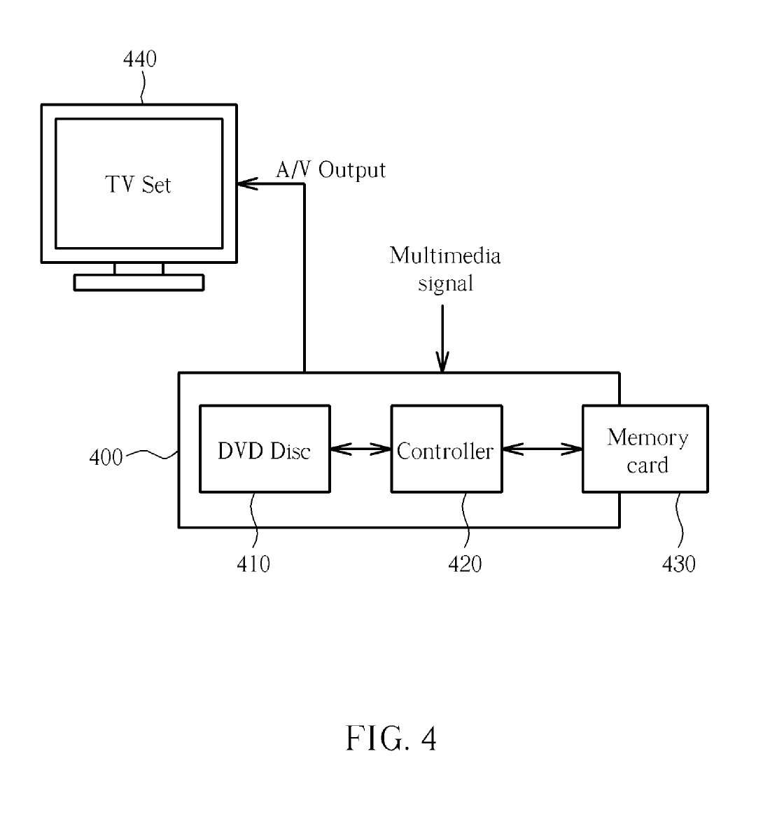

In another embodiment, the multimedia data recorded in the memory card 110 can be further recorded and saved in a non-volatile storage device, e.g., a magnetic storage medium or an optical storage medium. FIG. 4 illustrates a DVD recorder 400 with a memory card interface as an example. As shown in FIG. 4, the DVD recorder 400 includes a DVD disc 410 and a controller 420. Please note that only elements pertinent to technical features of the present invention are shown in FIG. 4. The controller 420 is basically provided with the same time-shift recording function as mentioned above, hence the following is in light of the recording from the memory card 430 to the DVD disc 410.

In this embodiment, a user can control the controller 420 to play time-shift recorded content in the memory card 430 and select a recording-start time (for example, by pressing the RECORD key) while the time-shift recording is carried out. The controller 420 copies the multimedia data recorded on the memory card 430 from that time point into the DVD disc 410 and updates a file system of the DVD disc 410. In addition, the present invention is able to save the program currently played on the TV 440 onto both the memory card 430 and the DVD disc 410 once the user press the RECORD key while watching TV 440. The file system of the memory card 430 does not need to be modified and a title is created in the file system of the DVD disc 410 during the recording process.

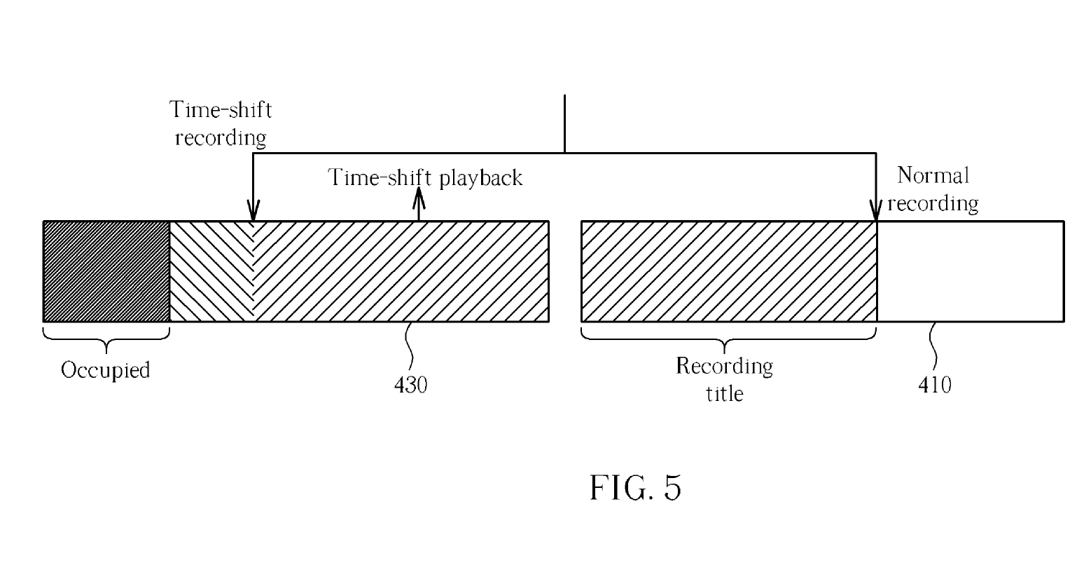

In other words, time-shift recording, copying, and playback function can be executed concurrently. High-speed dubbing is one of the copying techniques that the controller 420 utilizes to copy the multimedia data from the memory card 430 to the DVD disc 410. If the dubbing speed is fast enough, the time-shift recorded content in the memory card 430 does not need to be overwritten before it is copied into the DVD disc 410. After the portion of buffered time-shift content in the memory card 430 is copied completely, the controller 420 records the multimedia data on the memory card 430 and the DVD disc 410 at the same time, as shown in FIG. 5. Note that the multimedia data is recorded in the normal speed (not in high-speed mode) or real-time recording speed to the same title in the file system of the DVD disc 410. In this way, the multimedia data can continue recording on the DVD disc 410 even when the memory card 430 is removed from the DVD recorder 400. In order to guarantee a quick response of time-shift playback operation, the time-shift playback is always limited to the time-shift content in the memory card 430, not from the DVD disc 410.

The DVD disc is only one embodiment of the present invention, and is not meant to be a limitation. For example, the non-volatile storage device can be implemented by a hard disk drive or another memory card, etc., as long as a title can be created in the file system of the hard disk drive or the memory card. Additionally, the TV set system 100 and the DVD recorder 400 disclosed above are only examples of the present invention. The present invention is not limited to be applied in TV set system 100 or the DVD recorder 400. Other designs that obey the spirit of the present invention shall all fall within the scope of the present invention.

In the above embodiments, the controller 120 (420) automatically records the multimedia data without modifying a file system when a removable storage device 110 (430) having free space is detected as being attached. Therefore, when the removal of the removable storage device is detected, no data is flushed into the removable storage device 110 (430) and the time-shifting function can be stopped easily. The removable storage device 110 (430) is not limited by such mechanical limitations as the conventional DVD or HDD, and therefore problems in the prior arts are overcome in the present invention.

Those skilled in the art will readily observe that numerous modifications and alterations of the device and method may be made while retaining the teachings of the invention.

What is claimed is:

1. A method of recording multimedia data, comprising:
providing a removable storage device; and
recording multimedia data onto the removable storage device without modifying a file system of the removable storage device.

2. The method of claim 1, further comprising:
checking if there is free space in the removable storage device before recording multimedia data into the removable storage device, wherein the recording multimedia data into the removable storage device is performed when there is free space on the removable storage device.

3. The method of claim 2, wherein checking if there is free space in the removable storage device is actuated automatically when the removable storage device is attached and detected.

4. The method of claim 2, further comprising:
determining an encoding quality according to a size of the free space; and
before the multimedia data is recorded onto the free space of the removable storage device, encoding the multimedia data according to the encoding quality.

5. The method of claim 1, wherein the removable storage device is a memory card.

6. The method of claim 1, further comprising:
when the removable storage device is full but the multimedia data is still being recorded, overwriting the multimedia data on a used space of the removable storage device having the multimedia data recorded therein.

7. The method of claim 1, further comprising:
providing a non-volatile storage device; and
copying at least one portion of the multimedia data recorded on the removable storage device onto the non-volatile storage device and updating a file system of the non-volatile storage device.

8. The method of claim 7, further comprising:
recording the multimedia data on the removable storage device and the non-volatile storage device at the same time when the portion of the multimedia data is completely copied onto the non-volatile storage device.

9. The method of claim 1, wherein recording multimedia data into the removable storage device further comprises continuing to record the multimedia data onto the removable storage device until a removal of the removable storage device is detected.

10. The method of claim 1, wherein recording multimedia data onto the removable storage device is actuated automatically when the removable storage device is attached and detected.

11. An apparatus for recording multimedia data, comprising:
a removable storage device;
a controller, coupled to the removable storage device, for recording multimedia data onto the removable storage device without modifying a file system of the removable storage device.

12. The apparatus of claim 12, wherein the controller further checks if there is free space on the removable storage device, and when there is free space on the removable storage device, the controller records the multimedia data on the free space of the removable storage device without modifying a file system of the removable storage device.

13. The apparatus of claim 13, wherein the controller automatically checks if there is free space on the removable storage device when the removable storage device is attached and detected.

14. The apparatus of claim 13, wherein the controller further determines an encoding quality according to a size of the free space, and encodes the multimedia data according to the encoding quality before the multimedia data is recorded onto the free space of the removable storage device.

15. The apparatus of claim 12, wherein the removable storage device is a memory card.

16. The apparatus of claim 12, wherein the controller further overwrites the multimedia data on a used space of the removable storage device having the multimedia data recorded therein when the removable storage device is full but the multimedia data is still being recorded.

17. The apparatus of claim 12, further comprising a non-volatile storage device, coupled to the controller; and the controller further copies at least one portion of the multimedia data recorded on the removable storage device onto the non-volatile storage device and updates a file system of the non-volatile storage device.

18. The apparatus of claim 18, wherein the controller further records the multimedia data on the removable storage device and the non-volatile storage device at the same time when the portion of the multimedia data is completely copied onto the non-volatile storage device.

19. The apparatus of claim 18, wherein the non-volatile storage device is a magnetic storage medium or an optical storage medium.

20. The apparatus of claim 12, wherein the controller continues to record the multimedia data onto the removable storage device until a removal of the removable storage device is detected.

21. The apparatus of claim 12, wherein the controller automatically records the multimedia data onto the removable storage device when the removable storage device is attached and detected.
